(19) United States
(12) Patent Application Publication
(10) Pub. No.: US 2022/0210304 A1
(43) Pub. Date: Jun. 30, 2022

(54) ADJUSTABLE CAMERA SYSTEMS FOR DISPLAYS

(71) Applicant: Hewlett-Packard Development Company, L.P., Spring, TX (US)

(72) Inventors: Paul Roberto Lalinde, Spring, TX (US); Daniel James Braden, Spring, TX (US); Brian Wesley Walker, Spring, TX (US); Gregory C. Franke, Spring, TX (US); Christopher Rijken, Spring, TX (US); David Bradley Short, San Diego, CA (US)

(73) Assignee: Hewlett-Packard Development Company, L.P., Spring, TX (US)

(21) Appl. No.: 17/599,832

(22) PCT Filed: Jul. 26, 2019
(86) PCT No.: PCT/US2019/043616

§ 371 Date: Sep. 29, 2021

(51) Int. Cl. H04N 5/225; H04N 1/00

(52) U.S. Cl. CPC H04N 5/2257; H04N 1/00129; G06F 1/1605; H04N 5/2254; H04N 5/2252; H04N 1/00551

(57) ABSTRACT

An apparatus includes an integrated camera/scanner system built into the display housing of a display device. The apparatus includes a camera housing contained within the display housing. A door is attached to the camera housing in a pivoting manner. A minor is affixed to a planar surface of the door, where the planar surface faces inward into the camera housing. A camera is housed within the camera housing. The camera is mounted in the camera housing in a manner that allows the camera to pivot to adjust an angle of image capture. An actuator moves the camera housing in and out of the display housing.

### BACKGROUND

Integrated scanner/camera systems are peripheral devices that may be used in conjunction with a display of a computing system. An integrated scanner/camera system may combine the functionality of both a traditional digital camera and an image scanner. For example, the integrated scanner/camera system may include optics that allow a digital camera to additionally function as the image sensor portion of the image scanner.

### BRIEF DESCRIPTION OF THE DRAWINGS

FIG. 1 illustrates an example integrated scanner/camera system of the present disclosure;

FIG. 2A illustrates the integrated scanner/camera system of FIG. 1 with the door in an open position;

FIG. 2B illustrates the integrated scanner/camera system of FIG. 1 with the door in a closed position;

FIG. 3 illustrates a block diagram of an example of the display device of FIG. 1;

FIG. 4 illustrates a flow diagram of an example method for scanning a target object using a built-in, integrated scanner/camera system of the present disclosure; and

FIG. 5 is a block diagram of an example non-transitory computer-readable storage medium storing instructions executed by a processor to scan a target object using a built-in, integrated scanner/camera system of the present disclosure.

### DETAILED DESCRIPTION

Examples described herein provide an adjustable camera system for a display, which may function as a built-in, integrated scanner/camera system. As discussed above, an integrated scanner/camera system may combine the functionality of both a traditional digital camera and an image scanner. Integrated scanner/camera systems may be used in a variety of applications, including medical imaging, personal computing, self-service photo printing systems, and the like. Using an integrated scanner/camera system in place of a separate camera and image scanner allows the same functionality to be obtained with fewer components, resulting in a more compact system.

However, integrated scanner/camera systems still tend to be bulky, and some users may find this bulk to be unsightly. Moreover, where space for peripherals may be limited, even an integrated scanner/camera system may not be compact enough. In addition, many integrated scanner/camera systems connect to power sources and other resources that are external to the computing device and/or display device with which the integrated scanner/camera systems are used. For instance, these integrated scanner/camera systems may include large power adapters that allow the integrated scanner/camera systems to draw power from the mains electric (e.g., from a wall outlet). These power adapters may consume even more space.

Examples herein provide an integrated scanner/camera system that is compact and that can be built into the housing of a display device, such as a computer monitor or television, to further minimize consumption of space. The integrated scanner/camera system may include a door that is pivotally attached to a camera housing. A mirror may be affixed to an inward facing (i.e., facing into the camera housing) surface of the camera housing. A camera may be housed within the camera housing and may also be mounted in a manner that allows the camera to pivot towards or away from the camera housing. The camera may also be able to rotate.

When the integrated scanner/camera system is not in use, the door may be closed, and the camera may be concealed within the camera housing. The entire camera housing may be concealed within a compartment of the display housing. When the integrated scanner/camera system is used as a camera (e.g., for imaging of a three-dimensional object), the camera housing may pop out of the display housing. The door may open, and the camera may pivot and/or rotate to an angle or orientation that allows the camera to capture an image of a target object. When the integrated scanner/camera system is used as an image scanner (e.g., for imaging of a two-dimensional object), the target object may be placed on a surface near the display device. When the housing pops out and the door opens, the mirror may be positioned to reflect an image of the target object. The camera may then pivot and/or rotate to an angle or orientation that allows the camera to capture an image of the reflected image.

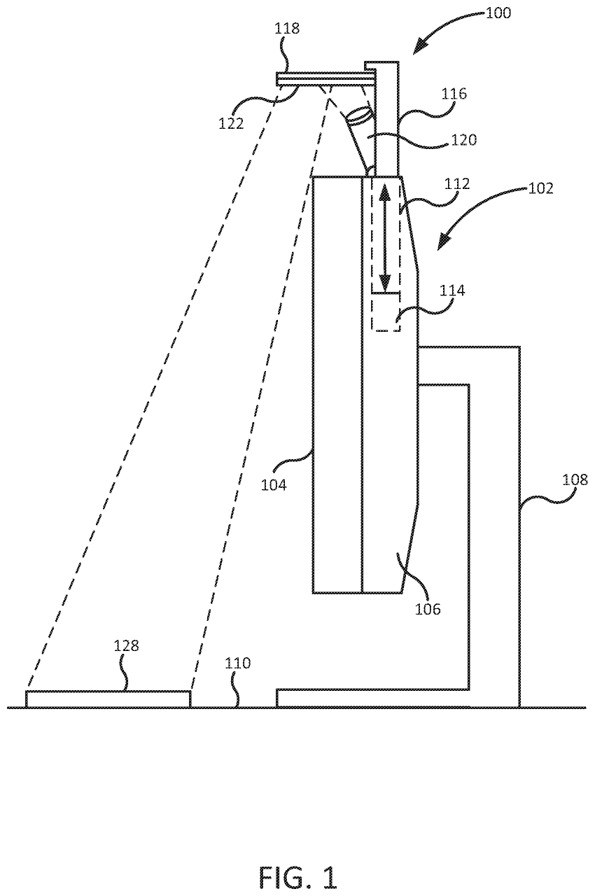

FIG. 1 illustrates an example integrated scanner/camera system 100 of the present disclosure. In an example, the system 100 may be built into a display device 102. The display device 102 may be a monitor of a computing system, a television, a display of a medical imaging system, a display of a self-service photo printing system, or any other device that can be used to display images and text. Thus, the display device 102 may work with a computing device or be part of an all-in-one computing device.

In one example, the display device 102 may include a screen 104, a display housing 106, and a support 108. The screen 104 may comprise a liquid crystal display (LCD), and organic light emitting diode (OLED) display, an LED display, a plasma display, a cathode ray tube (CRT) display, a thin film transistor (TFT) display, an electronic paper display, or any other type of screen. The screen 104 may also be a touch screen, so that the screen 104 may function as an input device as well as an output device.

The display housing 106 may support the screen 104 in an orientation for viewing by a viewer. The display housing 106 may also house various electronics for operating the display device 102, such as a power supply, a backlight, and other components. The support 108 may be coupled to the display housing 106 and may allow the display 102 to be rested on a support surface 110, such as a desk, a floor, a counter, or the like. The support 108 may include movable components (not shown) that allow the height and/or tilt of the screen 104 to be adjusted.

In one example, the display housing 106 also houses the integrated scanner/camera system 100. For instance, the display housing 106 may include a compartment 112 that is sized to house the integrated scanner/camera system 100 such that the integrated scanner/camera system 100 is completely concealed when not in use. The compartment 112 may further include an actuator 114 that drives the integrated scanner/camera system 100 within the compartment 112. For instance, the actuator 114 may push the integrated scanner/camera system 100 out of the compartment 112 (i.e., so that the integrated scanner/camera system 100 protrudes above the top of the display housing 106 as shown in FIG. 1) when the integrated scanner/camera system 100 is in use. When the integrated scanner/camera system 100 is not in use, the actuator 114 may retract the integrated scanner/camera system 100 back into the compartment 112. The actuator 114 may comprise, for example, a linear actuator, an electric motor, a hydraulic piston, or any other type of device that is capable of moving the integrated scanner/camera system 100 in and out of the compartment 112.

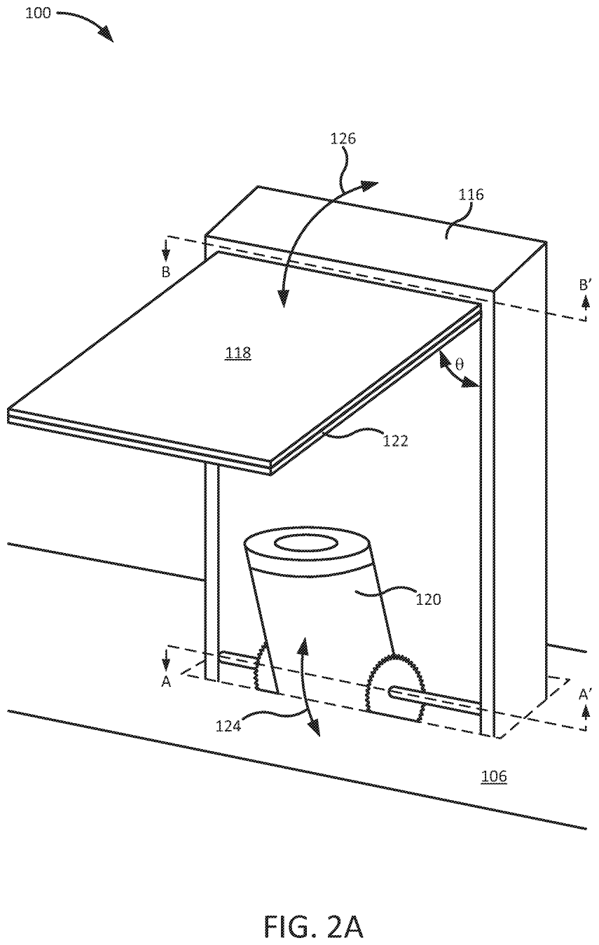

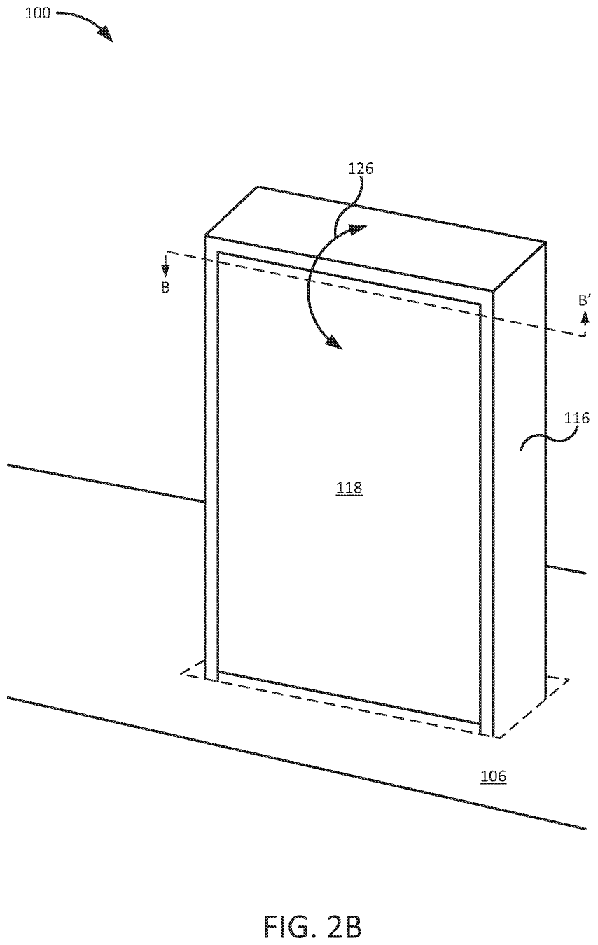

In one example, the integrated scanner/camera system 100 includes a camera housing 116, a door 118, a camera 120, and a mirror 122. Further details of the integrated scanner/camera system 100 are illustrated in FIG. 2A, which illustrates the integrated scanner/camera system 100 of FIG. 1 with the door 118 in an open position, and FIG. 2B, which illustrates the integrated scanner/camera system 100 of FIG. 1 with the door 118 in a closed position.

Referring simultaneously to FIGS. 1, 2A, and 2B, the camera housing 116 and the door 118, which is pivotally attached to the housing 116, together may form a hollow interior space within which the camera 120 may be housed. In addition, the camera housing 116 may be coupled to the actuator 114.

The door 118 may be attached to the camera housing 116 in a manner that allows the door 118 to pivot between an open position (shown in FIG. 2A, e.g., where the door 118 is orientated substantially parallel to the support surface 110) and a closed position (shown in FIG. 2B, where the door 118 is orientated substantially perpendicular to the support surface 110). Thus, the door 118 may be attached to the camera housing 116 via an attachment mechanism such as a hinge, a spring, or the like. The attachment mechanism may allow the door 118 to pivot about the axis B-B′, as shown by the arrow 126. In one example, the door 118 has a range of motion about the axis B-B′ of at least ninety degrees.

The mirror 122 may be attached to a planar surface of the door 118, and more specifically is attached to the inward facing (i.e., facing into the interior of the camera housing 116) planar surface of the door 118. Thus, the mirror 122 is concealed when the door 118 is closed, as shown in FIG. 2B. When the door 118 opens, the mirror 122 is exposed as shown in FIGS. 1 and 2A.

In another example, the mirror 122 may comprise the inward facing planar surface of the door 118. For instance, the inward facing surface of the door 118 may comprise a mirrored surface. Thus, the mirror 122 may not be a separate component mounted to the door 118.

The camera 120 may be housed within the camera housing 116. The camera 120 may comprise, for example, a digital camera such as a red, green, blue (RGB) camera. The camera 120 may be mounted in the camera housing 116 in a manner that allows the camera 120 to pivot to adjust an angle of image capture. For instance, the camera 120 may be mounted to an axle or coupled to an actuator that rotates the camera 120 about an axis A-A′, as shown by the arrow 124. In one example, the axis A-A′ is parallel to, but not collinear with, the axis B-B′ about which the door 118 rotates.

Referring back to FIG. 1, when the integrated scanner/camera system 100 is in use as an image scanner (e.g., for imaging of a two-dimensional object), a target object 128 (such as a document, a photo, or the like) may be placed on a surface near the display device 102. For instance, the target object 128 may be placed on the support surface 110, in front of or to the side of the screen 104.

When the camera housing 116 ejects out of the compartment 112, the door 118 may open. In one example, when the door 118 opens, the door 118 pivots around the axis B-B′, so that the door 118 is substantially parallel with the support surface 110. For instance, the angle 8 between the door 118 and the camera housing 116 may be between eighty-five and ninety degrees. This positioning of the door 118 exposes the mirror 122 and positions the mirror 122 to reflect an image of the target object 128.

The camera 120 may then pivot and/or rotate about the axis A-A′ to an angle or orientation that allows the camera 120 to capture an image of the reflected image in the surface of the mirror 122. In one example, the camera 120 has a range of motion about the axis A-A′ that is between thirty-five and fifty degrees. Thus, the positioning of the mirror 122 and camera 120 allows the camera's field of view to clear the front of the display device 102 as shown in FIG. 1 so that an image of the target object 128 can be captured.

Although the integrated scanner/camera system 100 is illustrated as ejecting from the top of the display device 102, it will be appreciated that in other examples, the integrated scanner/camera system 100 may eject from other locations on the display device 102, inducing the sides and/or bottom of the display device 102. In such a case, the integrated scanner/camera system 100 may be oriented so that the axes A-A′ and/or B-B′ are substantially parallel to the surface of the display device 102 from which the integrated scanner/camera system 100 ejects. In other examples, however, one or more of the axes A-A′ and/or B-B′ may be aligned differently (e.g., perpendicular to the surface of the display device 102 from which the integrated scanner/camera system 100 ejects) to allow for better imaging of the target object 128.

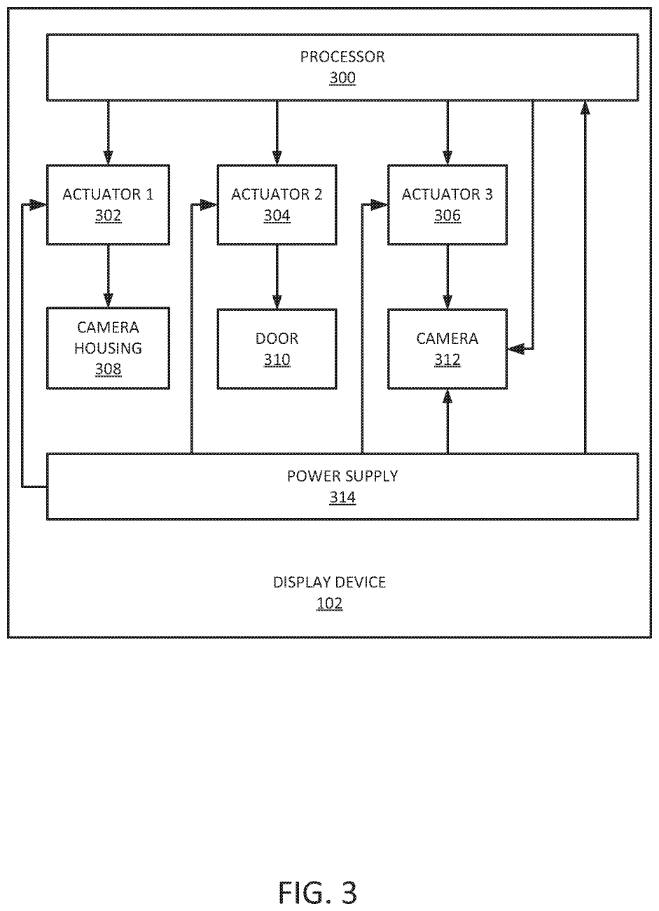

FIG. 3 illustrates a block diagram of an example the display device 102 of FIG. 1. In an example, the display device 102 may include a processor 300, a first actuator 302, a second actuator 304, a third actuator 306, a camera housing 308, a door 310, a camera 312, and a power supply 314.

In one example, the processor 300 may be part of the display device 102 in devices such as an all-in-one computer. In another example, the processor 300 may be part of a computing device that is communicatively coupled to the display device 102. In another example, the processor 300 may be part of the display device 102 and may operate independent of any computing device.

The first actuator 302, the second actuator 304, the third actuator 306, the camera housing 308, the door 310, and the camera 312 may collectively form an integrated scanner/camera system as discussed above.

The processor 300 may be communicatively coupled to the first actuator 302, the second actuator 304, the third actuator 306, and the camera 312. Thus, the processor 300 may send signals to the first actuator 302, the second actuator 304, the third actuator 306, and/or the camera 312 that contain instructions for taking certain actions connected to image capture (e.g., capturing photographs of or scanning target objects).

The first actuator 302 may be physically coupled to the camera housing 308. In one example the camera housing 308 may house the camera 312. In one example, the first actuator 302 may, under instruction from the processor 300, move the camera housing 308 linearly, so that the camera housing 308 is either concealed within or protrudes from the display device 102. Thus, in one example, the first actuator 302 may be the actuator 114 of FIG. 1, and the camera housing 308 may be the camera housing 116 of FIG. 1.

The second actuator 304 may be physically coupled to the door 310. In one example, the door 310 is physically coupled to the camera housing 308. In one example, the second actuator 304 may, under instruction from the processor 300, rotate or pivot the door 310 about a first axis in order to open the camera housing 308 and expose the camera 312.

The third actuator 306 may be physically coupled to the camera 312. In one example, the third actuator 306 may, under instruction from the processor 300, rotate or pivot the camera 312 about a second axis in order to position the camera 312 for image capture.

As discussed above, the camera 312 may also be communicatively coupled to the processor 300. In one example, the camera 312 may, under instruction from the processor 300, capture an image of a target object that is placed in proximity to the display device 102.

As also discussed above, the display device 102 may further include a power supply 314. The power supply 314 may be communicatively coupled to the processor 300, the first actuator 302, the second actuator 304, the third actuator 306, and the camera 312. The power supply 314 may provide electrical power to the processor 300, the first actuator 302, the second actuator 304, the third actuator 306, and the camera 312. The power supply 314 may comprise a power adapter, a battery, or the like. Thus, a single power supply may provide electrical power to the display device (e.g., to render images on the screen) as well as to the integrated scanner/camera system.

It should be noted that the display device 102 has been simplified for ease of explanation. For instance, the display device 102 may include components that are not illustrated in FIG. 3, such as a memory (e.g., a non-transitory computer readable medium such as hard disk drive, a solid state drive, a read-only memory (ROM), a random access memory (RAM), or the like), light emitting diodes, additional display panels, and so forth.

Although the above-discussed examples of the built-in, integrated scanner/camera system have been described as a pop-up system that can be concealed within the display housing, it will be appreciated that in further examples, the integrated scanner/camera system may not be built in. For instance, a similarly configured integrated scanner/camera system, including at least a pivoting mirror and an independently pivoting camera, may be arranged for external attachment to the display device. Such an arrangement would allow existing display devices, regardless of make or model, to be retrofitted with a compact integrated scanner/camera system. In this case, the integrated scanner/camera system may be mounted externally (and removably) to the top of the display device or to one of the sides of the display device.

Furthermore, the integrated scanner/camera system of the present disclosure may accommodate most commercially available scanners, as well as three-dimensional cameras and projection cameras. The integrated scanner/camera system may also operate as a projector. For instance, the camera may display an image (e.g., from a memory of the display device or a connected computing device) that is reflected by the mirror and projected onto the support surface.

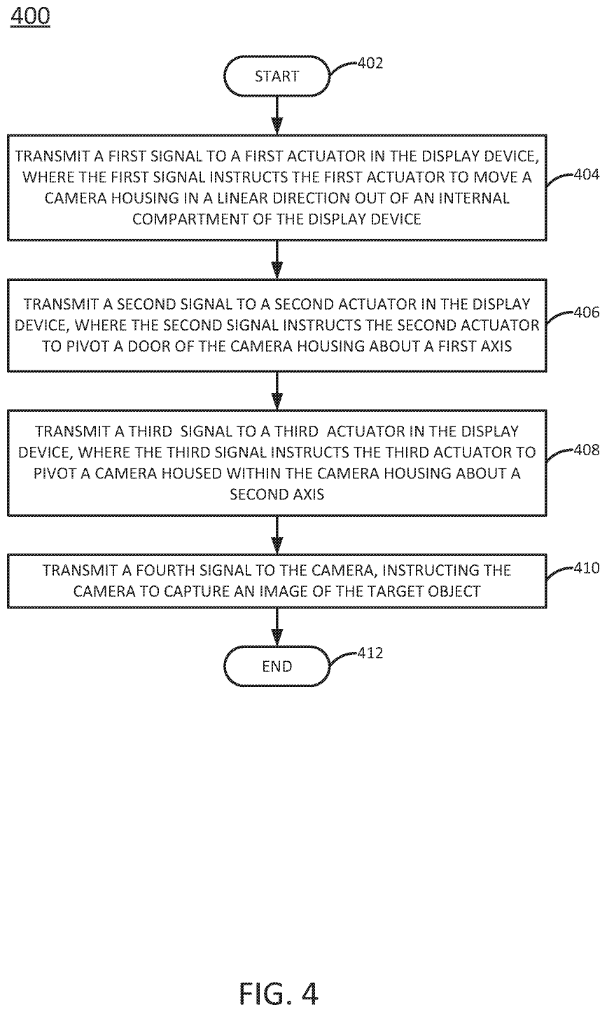

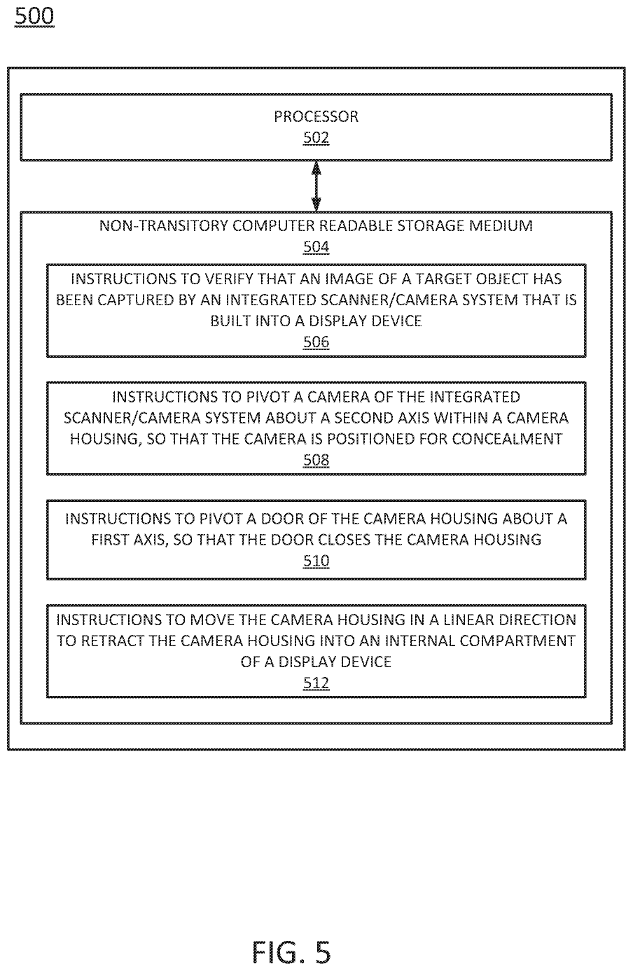

FIG. 4 illustrates a flow diagram of an example method 400 for scanning a target object using a built-in, integrated scanner/camera system of the present disclosure. In an example, the method 400 may be performed by the display device 102 or the apparatus 500 illustrated in FIG. 5 and discussed below.

At block 402, the method 400 begins. At block 404, the method 400 may transmit a first signal to a first actuator in the display device, where the first signal instructs the first actuator to move a camera housing in a linear direction out of an internal compartment of the display device.

The display device may be a monitor of a computing system, a television, a display of a medical imaging system, a display of a self-service photo printing system, or any other device that can be used to display images and text. Thus, the display device may work with a computing device or be part of an all-in-one computing device. The camera housing may be concealed within the internal compartment of the display device, but may be capable of moving in and out of the internal compartment under the influence of the first actuator.

The first signal may be transmitted in response to the receipt an input signal from a user, e.g., via an input/output device coupled to the display device, to scan a target object that is placed in proximity to the display device. In one example, the target object may be placed on a same support surface as the display device, but in front of or to the side of the display device.

At block 406, the method 400 may transmit a second signal to a second actuator in the display device, where the second signal instructs the second actuator to pivot a door of the camera housing about a first axis. In one example, the second signal may specify an amount (e.g., a number of degrees) by which to pivot the door. In one example, the amount is at least ninety degrees. In one example, the door may be pivoted to a position that allows a mirror or mirrored surface of the door to reflect an image of the target object.

At block 408, the method 400 may transmit a third signal to a third actuator in the display device, where the third signal instructs the third actuator to pivot a camera housed within the camera housing about a second axis. In one example, the third signal may specify an amount (e.g., a number of degrees) by which to pivot the camera. For instance, a sensor of the display device may detect a location of the target object and transmit the location to a processor that determines the proper orientation of the camera for scanning. In another example, the target object may be placed within a designated area that has been pre-calibrated for scanning. In this case, the proper orientation of the camera for scanning an object placed within the designated area may be known and pre-programmed. In one example, the camera may be pivoted to an orientation in which the camera can capture an image reflected in a mirror or mirrored surface of the door.

At block 410, the method 400 may transmit a fourth signal to the camera, instructing the camera to capture an image of the target object. As discussed above, the camera may capture an image of the target object as reflected in a mirror or mirrored surface of the door.

At block 412, the method 400 may end.

FIG. 5 illustrates an example of an apparatus 500. In an example, the apparatus 500 may be the display device 102. In an example, the apparatus 500 may include a processor 502 and a non-transitory computer readable storage medium 504. The non-transitory computer readable storage medium 504 may include instructions 506, 508, 510, and 512 that, when executed by the processor 502, cause the processor 502 to perform various functions related to scanning a target object using a built-in, integrated scanner/camera system of the present disclosure.

In an example, the instructions 506 may include instructions to verify that an image of a target object has been captured by an integrated scanner/camera system that is built into a display device. The instructions 508 may include instructions to pivot a camera of the integrated scanner/camera system about a second axis within a camera housing, so that the camera is positioned for concealment. The instructions 510 may include instructions to pivot a door of the camera housing about a first axis, so that the door closes the camera housing (effectively concealing the camera). The instructions 512 may include instructions to move the camera housing in a linear direction to retract the camera housing into an internal compartment of a display device.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a display including a display housing;
a camera housing contained within the display housing;
a door attached to the camera housing in a pivoting manner;
a mirror affixed to a planar surface of the door, wherein the planar surface faces inward into the camera housing;
a camera housed within the camera housing, wherein the camera is mounted in the camera housing in a manner that allows the camera to pivot to adjust an angle of image capture; and
an actuator to move the camera housing in and out of the display housing.

2. The apparatus of claim 1, wherein the display housing includes a compartment that is sized to conceal the camera housing when the camera housing is retracted into the compartment.

3. The apparatus of claim 2, wherein the actuator moves the camera housing linearly within the compartment.

4. The apparatus of claim 1, wherein the camera housing and the door together form a hollow space within which the camera is housed.

5. The apparatus of claim 1, wherein the actuator is a first actuator, and wherein the apparatus further comprises:
a second actuator to pivot the door about a first axis; and
a third actuator to pivot the camera about a second axis.

6. The apparatus of claim 5, wherein the door has a range of motion of at least ninety degrees about the first axis.

7. The apparatus of claim 5, wherein the second axis is parallel to the first axis.

8. The apparatus of claim 1, wherein the camera and the actuator draw power from a power supply of the display.

9. A method, comprising:
transmitting a first signal to a first actuator in a display device, wherein the first signal instructs the first actuator to move a camera housing in a linear direction out of an internal compartment of the display device;
transmitting a second signal to a second actuator in the display device, wherein the second signal instructs the second actuator to pivot a door of the camera housing about a first axis;
transmitting a third signal to a third actuator in the display device, wherein the third signal instructs the third actuator to pivot a camera housed within the camera housing about a second axis; and
transmitting a fourth signal to the camera, wherein the fourth signal instructs the camera to capture an image of a target object that is placed in proximity to the display device.

10. The method of claim 9, wherein the method is performed by a processor of the display device.

11. The method of claim 9, wherein a planar surface of the door that faces inward into the camera housing includes a mirror.

12. The method of claim 11, wherein the third signal instructs the camera to rotate to an angle at which the camera can capture an image of the target object that is reflected in the mirror.

13. A non-transitory computer readable storage medium encoded with instructions executable by a processor, the non-transitory computer-readable storage medium comprising:
instructions to verify that an image of a target object has been captured by an integrated scanner/camera system that is built into a display device;
instructions to pivot a camera of the integrated scanner/camera system about a second axis within a camera housing, so that the camera is positioned for concealment;
instructions to pivot a door of the camera housing about a first axis, so that the door closes the camera housing; and
instructions to move the camera housing in a linear direction to retract the camera housing into an internal compartment of a display device.

14. The non-transitory computer readable storage medium of claim 13, wherein the processor is part of the display device.

15. The non-transitory computer readable storage medium of claim 13, wherein the camera draws power from a power supply of the display device.
